(19) United States
(12) Patent Application Publication
(10) Pub. No.: US 2023/0414994 A1
(43) Pub. Date: Dec. 28, 2023

(54) EASY CHAIR

(71) Applicant: TOYOTA BOSHOKU KABUSHIKI KAISHA, Aichi (JP)

(72) Inventor: Yasuhiro KATO, Aichi (JP)

(73) Assignee: TOYOTA BOSHOKU KABUSHIKI KAISHA, Aichi (JP)

(21) Appl. No.: 18/210,260

(22) Filed: Jun. 15, 2023

(30) Foreign Application Priority Data
Jun. 22, 2022 (JP) 2022-100312

(51) Int. Cl. A63B 23/02; B60N 2/02; A47C 1/03; A47C 1/024; A63B 71/06; A47C 7/72

(52) U.S. Cl. CPC A63B 23/0216; B60N 2/0224; A47C 1/0308; A47C 1/0242; A63B 71/0622; A47C 7/727; A63B 2208/0233; A63B 2071/0625; A63B 2220/51

(57) ABSTRACT

The present disclosure provides one example of an easy chair in light of market trends related to health and fitness. The easy chair of the present disclosure includes a seat body configured for a user to sit thereon, and further includes a monitoring part configured to determine whether the user is performing muscle strength training on the seat body and detect the user's performance of the muscle strength training, and a notification part configured to notify the user of a detection result of the monitoring part in a form of recognizable information.

### CROSS-REFERENCE TO RELATED APPLICATIONS

This application claims the benefit of Japanese Patent Application No. 2022-100312 filed on Jun. 22, 2022 with the Japan Patent Office, the entire disclosure of which is incorporated herein by reference.

### BACKGROUND

The present disclosure relates to an easy chair.

As disclosed in Japanese Unexamined Patent Application Publication No. H5-137630, an easy chair includes a movable portion for changing a posture of the easy chair.

### SUMMARY

In recent years, attention has been focused on markets related to health and fitness. The present disclosure discloses one example of an easy chair in light of market trends related to health and fitness.

An easy chair with a seat body configured for a user to sit thereon may comprise, for example, at least one of the following constituent features:
a monitoring part configured to detect whether the user is performing muscle strength training on the seat body, and detect the user's performance of the muscle strength training; and
a notification part configured to notify the user of a detection result of the monitoring part in a form of recognizable information.

A person who uses the easy chair to perform muscle strength training, that is, a user of the easy chair, can perform the muscle strength training while checking the detection result of the monitoring part. In other words, the user can perform the muscle strength training while receiving a feedback on its performance of the muscle strength training. Thus, according to the easy chair, it may be possible to increase the user's motivation for the muscle strength training.

The easy chair may be configured as below, for example.

The easy chair with a seat body configured for a user to sit thereon may comprise: a posture change mechanism including a movable portion for changing a posture of the seat body, the posture change mechanism being configured to displace the movable portion to a position for muscle strength training; a controller configured to control an operation of the posture change mechanism, the controller being configured to execute a first function to displace a position (posture) of the movable portion to the position (posture) for the muscle strength training when receiving an indication of the user's intention to perform the muscle strength training; a monitoring part configured to detect whether the user is performing the muscle strength training on the seat body and detect the user's performance of the muscle strength training; and a notification part configured to notify the user of a detection result of the monitoring part in a form of recognizable information, wherein the controller is configured to execute a second function to restore the position (posture) of the movable portion to a state before the first function is executed, when it is determined by the monitoring part that the muscle strength training has ended.

The easy chair can the user's motivation for the muscle strength training. In addition, it is possible to automatically set the posture of the easy chair to a posture suitable for the muscle strength training.

It is desirable that an easy chair with a seat body configured for a user to sit thereon may comprise: a posture change mechanism including a movable portion for changing a posture of the seat body; a first notification part configured to notify the user to displace a position of the movable portion to a position for muscle strength training in a form of recognizable information when receiving an indication of the user's intention to perform the muscle strength training; a monitoring part configured to detect whether the user is performing the muscle strength training on the seat body and detect the user's performance of the muscle strength training; and a second notification part configured to notify the user of a detection result of the monitoring part in a form of recognizable information.

The easy chair as above can increase the user's motivation for the muscle strength training. It is also possible to urge the user to automatically adjust the posture of the easy chair to a posture suitable for the muscle strength training.

It is desirable that the monitoring part is configured to use a detection value of a load sensor configured to detect a load acting on a surface of the seat body for determination.

### BRIEF DESCRIPTION OF THE DRAWINGS

An example embodiment of the present disclosure will be described hereinafter with reference to the accompanying drawings, in which:

FIG. 1 is a diagram showing a seat system according to a first embodiment;

FIG. 2 is a diagram showing an easy chair according to the first embodiment;

FIG. 3 is a diagram showing the easy chair according to the first embodiment;

FIG. 4 is a diagram showing the easy chair according to the first embodiment;

FIG. 5 is a diagram showing the easy chair according to the first embodiment;

FIG. 6 is an example flowchart showing an operation of the easy chair according to the first embodiment;

FIG. 7 is the example flowchart showing the operation of the easy chair according to the first embodiment;

FIG. 8 is an example flowchart showing the operation of the easy chair according to a second embodiment;

FIG. 9 is the example flowchart showing the operation of the easy chair according to the second embodiment;

FIG. 10 is a diagram showing the easy chair according to a third embodiment;

FIG. 11 is a diagram showing the easy chair according to a fourth embodiment;

FIG. 12 is a diagram showing the easy chair according to the fourth embodiment;

FIG. 13 is a diagram showing the easy chair according to a fifth embodiment;

FIG. 14 is a diagram showing the easy chair according to the fifth embodiment; and

FIG. 15 is a diagram showing the easy chair according to a sixth embodiment.

### DETAILED DESCRIPTION OF EXEMPLARY EMBODIMENTS

Embodiments below describe examples of embodiments within the technical scope of the present disclosure. Matters specifying the invention that are recited in the appended claims are not limited to any specific configuration, structure, or the like that is shown in the embodiments described below.

The present embodiment explains an example of a seat system related to a seat to be installed in a vehicle such as an automobile (hereinafter referred to as a vehicle seat). The present embodiment is an example of a seat system comprising a vehicle seat configured as an easy chair. The vehicle seat of the present embodiment is an example of an easy chair.

Arrows indicating directions, hatched lines, and so on in the figures are shown so as to facilitate understanding of mutual relationships among the figures, shapes of members or portions, and so on. The easy chair is not limited by the directions shown in the figures.

The directions shown in the figures correspond to directions in a state where the vehicle seat of the present embodiment is assembled in a vehicle. At least a member or portion described with a reference numeral assigned thereto is at least one in number unless accompanied by a specifying term, such as “only one”.

That is, the member or portion may be two or more in number if no specifying term, such as “only one”, is present. The easy chair of the present disclosure comprises at least elements including members and portions described with respective reference numerals assigned thereto, and structural portions shown in the drawings.

### First Embodiment

<1. Overview of Seat System>

The seat system 1 of the present embodiment comprises an operation portion 10 and an easy chair 20. The operation portion 10 receives an input from a user of the seat system 1 and transmits the input information to a monitoring part 31.

The operation portion 10 is provided on the easy chair 20 (more specifically, on an armrest 24, for example). The operation portion 10 is configured by a touch panel 11 integrated with a display device and an input device.

The operation portion 10 may be, for example, a touch panel 12 provided in a vehicle, or a mobile terminal 13 of the user, in place of the aforementioned touch panel 11. In this case, the touch panel 12 or the mobile terminal 13 may transmit information input via wireless communication or wired communication to the monitoring part 31.

The easy chair 20 is a seat body on which the user can sit. The easy chair 20 can be also understood as a vehicle seat. The easy chair 20 has a function for the user to use as a vehicle seat, a function for the user to sit in a relaxed state, and a function for the user to perform muscle strength training.

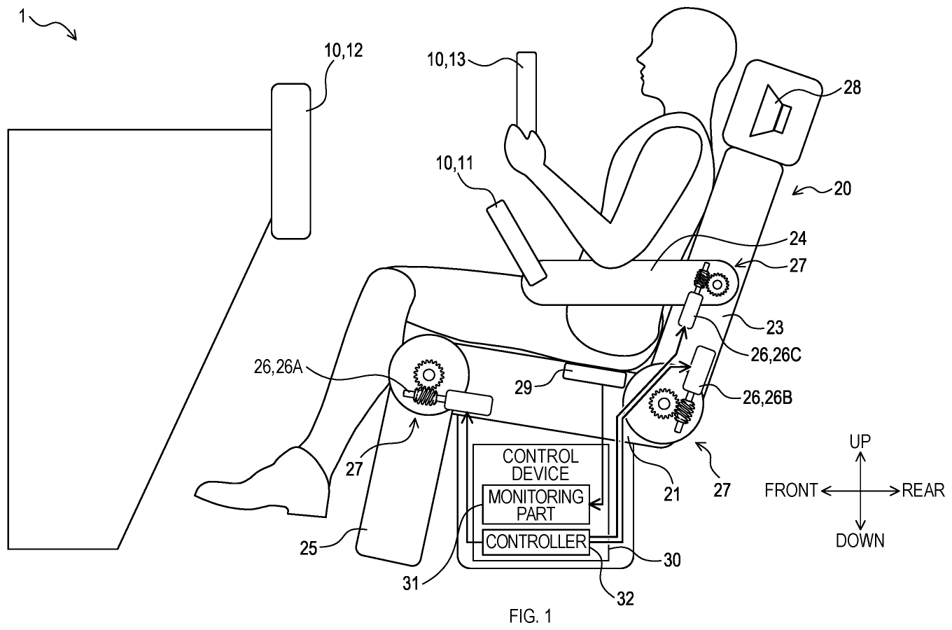

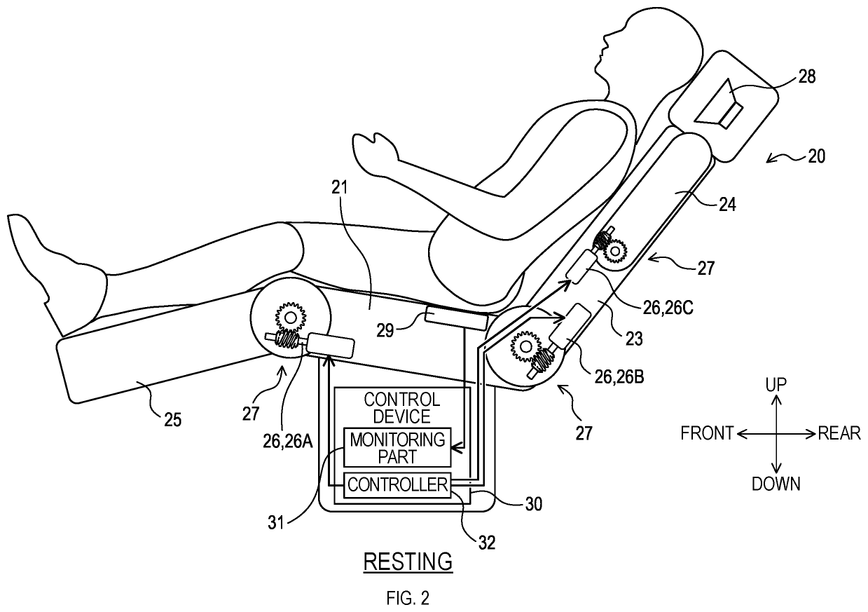

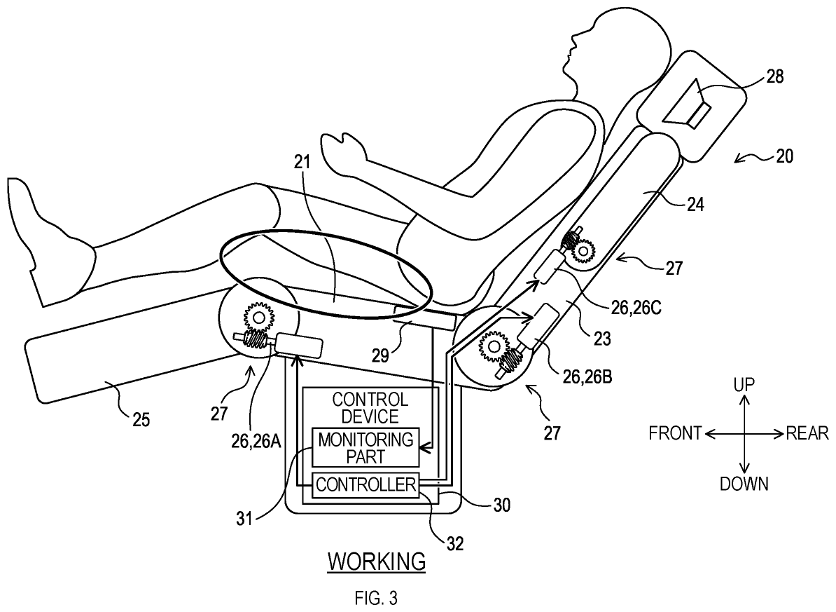

FIG. 1 shows the easy chair 20 being used as a vehicle seat, or in a relaxed state, and FIGS. 2 and 3 show the easy chair 20 when the user is performing the muscle strength training. Specifically, FIG. 2 shows a resting state during the muscle strength training, and FIG. 3 shows a working state during the muscle strength training.

<2. Easy Chair (Vehicle Seat)>

<2.1 Configuration of Easy Chair>

The easy chair 20, that is, the seat body, comprises a seat cushion 21, a seatback 23, the armrest 24, an ottoman 25, a moving mechanism 26, a speaker 28, a load sensor 29 and a control device 30, as shown in FIG. 2. The speaker 28 is a device that emits sound information.

The seat cushion 21 supports buttocks of an occupant. The seatback 23 supports a back of the occupant. The ottoman 25 supports legs, particularly calves, of the occupant.

The seatback 23 and the ottoman 25 are displaceable with respect to the seat cushion 21. The seatback 23 is arranged on a rear end side of the seat cushion 21, and is pivotable about a lower end part of the seatback 23.

The ottoman 25 is arranged on a front end side of the seat cushion 21, and is pivotable around an upper end part of the ottoman 25. This allows the user of the easy chair 20 to change a seated posture.

The armrest 24 supports the user's forearm. The armrest 24 is pivotably coupled to one end or the other end in a width direction of the seatback 23.

The seatback 23, the armrest 24, and the ottoman 25 constitute examples of a movable portion for changing the seated posture of the user (in other words, a posture of the easy chair 20). Hereinafter, the seatback 23, the armrest 24, and the ottoman 25 are also referred to as “movable portions 23, 24, 25” collectively.

The seatback 23, the armrest 24, and the ottoman 25 receive a drive force from the electrical moving mechanism 26 and are thereby displaced. A moving mechanism 26A for the ottoman 25, a moving mechanism 26B for the seatback 23, and a moving mechanism 26C for the armrest 24 each comprise an electric motor and a deceleration mechanism.

Each electric motor is one example of an electric actuator that generates a drive force. Each deceleration mechanism comprises two or more gears, and decelerates a rotation of the corresponding electric motor, thereby to increase a rotational force of the electric motor and output the increased rotational force to the ottoman 25, the armrest 24, and the seatback 23.

In the easy chair 20, the ottoman 25, the armrest 24, and the seatback 23 and the moving mechanisms 26A to 26C constitute a posture change mechanism 27 (an example of the posture change mechanism). The posture change mechanism 27 can set the seated posture of the user (in other words, the posture of the easy chair 20) to a normal posture or a training posture by displacing at least one of the movable portions 23, 24, 25.

The normal posture is the posture of the easy chair 20 when the easy chair 20 is used as a vehicle seat or in a relaxed state. FIG. 1 shows an example of positions of the movable portions 23, 24, 25 during the normal posture. The training posture is the posture of the easy chair 20 when the easy chair 20 is used during the muscle strength training. FIG. 2 shows an example of the positions of the movable portions 23, 24, 25 during the training posture.

The easy chair 20 has a memory function to store information of the posture (training posture) that the user feels is appropriate in advance or at any timing in a storage device. The control device 30 uses the memory function to change (control) the posture of the easy chair 20 to the training posture.

The easy chair 20 further comprises a sliding device (not shown). The sliding device is one example of a fixing portion configured to directly or indirectly fix the easy chair 20 to a vehicle. The sliding device comprises a mechanism that allows the easy chair 20 to be switched between a displaceable state and a non-displaceable state.

<2.2 Control Device, Etc.>

The control device 30 comprises the monitoring part 31 and a controller 32. The control device 30 is configured with a microcomputer including a CPU, a ROM, a RAM, and so on.

The monitoring part 31 and the controller 32 are implemented by the CPU executing a software. The software is stored in advance in a nonvolatile storage device (not shown) such as a ROM.

<Function of Monitoring Part>

The monitoring part 31 uses a detection value of the load sensor 29 to detect whether the user is performing the muscle strength training on the easy chair 20 and detect the user's performance of the muscle strength training.

The load sensor 29 is arranged on one of the portions of the easy chair 20, and detects a load acting on a surface of the easy chair 20. In an example, the load sensor 29 may be arranged in a portion corresponding to the buttocks of the user seated on the seat cushion 21. Hereinafter, a description of this case will be given.

The detection value of the load sensor 29 is input to the monitoring part 31. The monitoring part 31 detects the performance of the muscle strength training using an increase or decrease in detection value. For example, in a case where a “muscle strength training of raising and lowering thighs” is performed as shown in FIG. 3, a detection value in a state in which the thighs are raised is greater than a detection value in a state in which the thighs are lowered.

The monitoring part 31 can receive an input of a target value for the muscle strength training. Specifically, the monitoring part 31 receives a value input to the operation portion 10 as a target value for the muscle strength training.

For example, in the “muscle strength training of raising and lowering thighs”, the target value may include a target time, a target number of times, etc. The target time is “time during which the thighs are raised”. The target number of times is “number of times the thighs are raised and lowered”.

The monitoring part 31 can determine whether the muscle strength training has ended based on the target value. Specifically, when a “duration of the thighs being raised” detected by the monitoring part 31 exceeds the target time, and the number of times the target time is exceeded (hereinafter, number of executions) reaches the target number of times, the monitoring part 31 determines that “the muscle strength training has ended”.

Further, the monitoring part 31 controls an operation of the speaker 28. Specifically, the monitoring part 31 notifies the user of the “duration of the thighs being raised”, “number of times the duration exceeds the target time” and “end of the muscle strength training” as a detection result by sound information.

<Function of Controller>

The controller 32 controls an operation of the posture change mechanism 27. Specifically, the controller 32, when receiving an indication of the user's intention to perform the muscle strength training, can displace at least one of the movable portions 23, 24, 25 to execute a first function to displace the posture of the easy chair 20 to the training posture.

Further, the controller 32, when it is determined by the monitoring part 31 that the muscle strength training has ended, can execute a second function to restore the corresponding one of the movable portions 23, 24, 25 displaced when the first function is executed to a state before the first function is executed.

<Detail of Example Operation of Monitoring Part and Controller>

The easy chair 20 can be displaced to a first training posture or a second training posture as the training posture. The first training posture is a training posture for a “muscle strength training of raising and lowering thighs (hereinafter, referred to as a first training mode)” (see FIGS. 2 and 3).

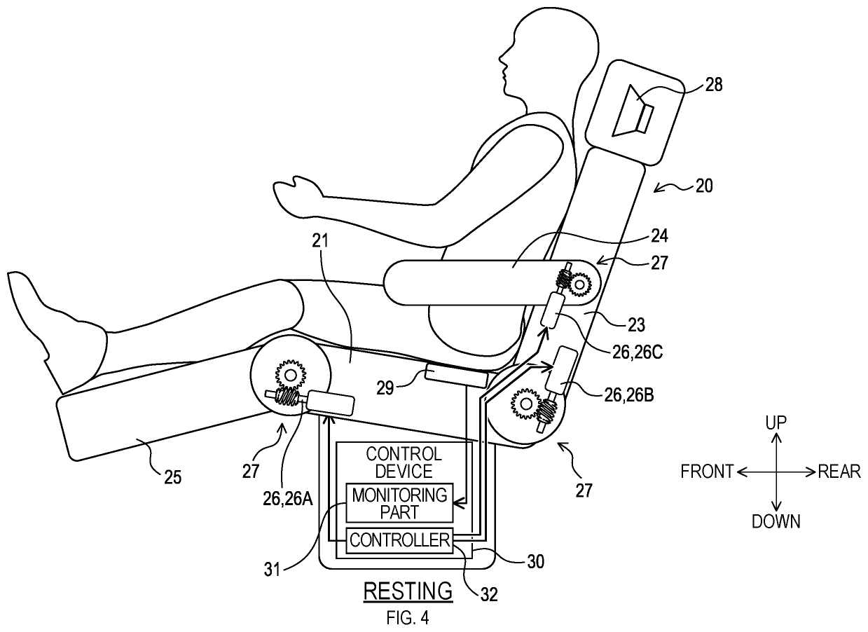

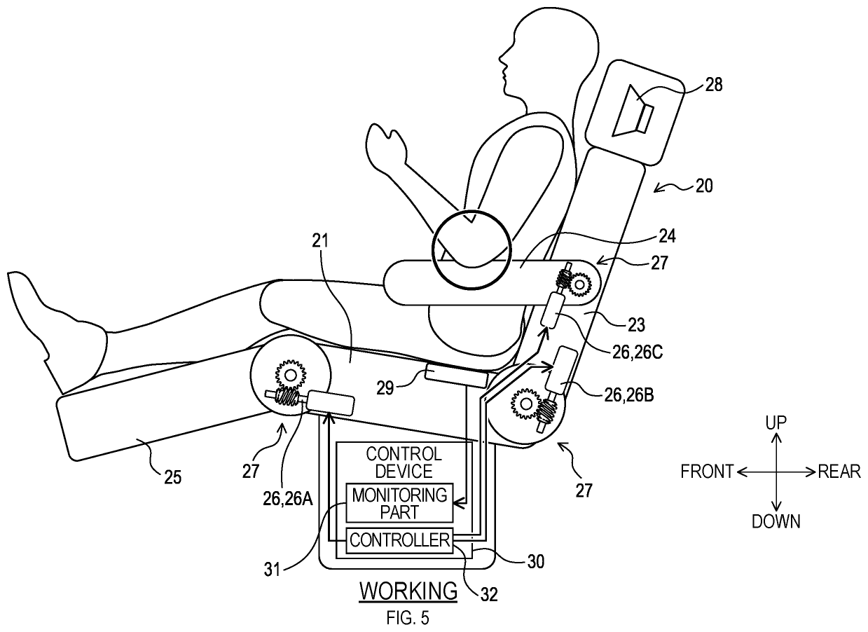

The second training posture is a training posture for a “muscle strength training for pectoral and brachial muscles (hereinafter, referred to as a second training mode)”. In the second training posture, the armrest 24 is in a substantially horizontal state (see FIG. 4). This state does not interfere with the user supporting itself with its elbows (see FIG. 5), and allows the user to train the pectoral and brachial muscles.

As described above, the function of the monitoring part 31 and the function of the controller 32 are implemented by the software being executed by the control device 30. Hereinafter, the monitoring part 31 and the controller 32 may be referred to as the control device 30 without distinction between the two.

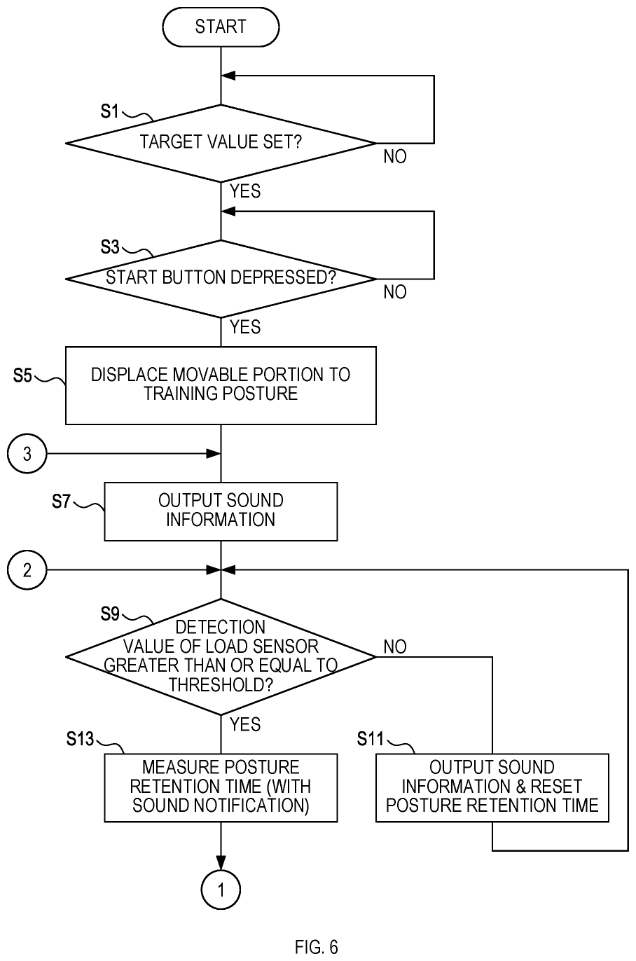

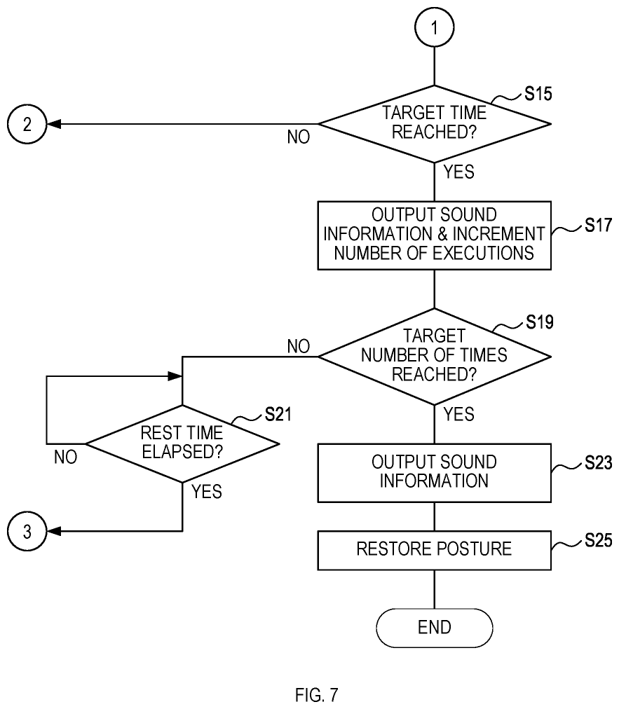

FIGS. 6 and 7 are an example flowchart showing the operation (control) of the easy chair 20 when the user performs the muscle strength training using the easy chair 20. The control is started when the user manipulates the operation portion 10 and selects the first training mode or the second training mode.

When the control is started, the control device 30 determines whether the target value corresponding to the selected training mode is input via the operation portion 10 (S1). When it is determined that the target value is not input (S1: NO), the control device 30 urges the user by sound information or image information such as a text to set the target value, and thereafter determines again whether the target value is input (S1).

When it is determined that the target value is input (S1: YES), the control device 30 determines whether a command to start the selected training is input via the operation portion 10, that is, whether the indication of the user's intention to perform the muscle strength training is received (S3).

Specifically, in S3, the control device 30 determines whether a start button (not shown) displayed on the operation portion 10 is depressed.

When it is determined that the start button is depressed (S3: YES), the control device 30 displaces the movable portions 23, 24, 25 to the training posture corresponding to the selected training mode (S5).

In the easy chair 20 of the present embodiment, the target value when the present control is executed last time is stored. Also, if the target value when the present control is executed last time is stored, the control device 30 determines that the target value is input, and executes S3.

When the posture of the easy chair 20 is changed to the training posture, the control device 30 outputs sound information for starting the training from the speaker 28 (S7). When the posture of the easy chair 20 already takes the training posture, the control device 30, while maintaining the current posture, outputs sound information for starting the training from the speaker 28 (S7).

Next, the control device 30 determines whether the detection value of the load sensor 29 is greater than or equal to a specific threshold (S9). When the detection value is smaller than the threshold (S9: NO), the control device 30 determines that the user is not performing the muscle strength training and outputs sound information for urging the user to perform the muscle strength training from the speaker 28, sets a below-described posture retention time to zero (0) (S11), and again executes S9.

The state in which “the user is not performing the muscle strength training” indicates, for example, in a case of the first training mode, a state in which “the thighs are not raised”. A “posture retention” state indicates a state in which “the thighs are raised”, that is, a state in which the muscle strength training is being performed.

When the detection value of the load sensor 29 is greater than or equal to the threshold (S9: YES), the control device 30 determines that the user is performing the muscle strength training, starts to measure the duration (hereinafter, referred to as the posture retention time) based on time of detection that the detection value is greater than or equal to the threshold (that is, when the posture retention state is established), and outputs the measured posture retention time by sound information from the speaker 28 (S13).

Next, the control device 30 determines whether the posture retention time has reached the target time (S15). When the posture retention time has not reached the target time (S15: NO), the control device 30 again executes S9.

When the posture retention time has reached the target time (S15: YES), the control device 30 outputs sound information for canceling the posture retention, that is, “the state in which the thighs are raised”, from the speaker 28, and increments the number of executions by one (S17). An initial value of the number of executions is zero (0).

Next, the control device 30 determines whether the number of executions has reached the target number of times (S19). When it is determined that the number of executions has not reached the target number of times (S19: NO), the control device 30 determines whether a specified rest time has elapsed (S21). When the rest time has elapsed (S21: YES), the control device 30 again executes S7.

When it is determined that the number of executions has reached the target number of times (S19: YES), the control device 30 outputs sound information for ending the training from the speaker 28 (S23), and thereafter restore the posture of the easy chair 20 to the original posture (the posture before the training posture) (S25).

<3. Characteristics of Easy Chair of Present Embodiment>

The easy chair 20 of the present embodiment comprises the monitoring part 31 configured to detect whether the user is performing the muscle strength training on the easy chair 20 and detect the user's performance of the muscle strength training, and notifies the user of the detection result of the monitoring part 31 in a form of recognizable information.

This allows the person who performs the muscle strength training using the easy chair 20, that is, the user, to perform the muscle strength training while checking the detection result of the monitoring part 3. In other words, the user can perform the muscle strength training while receiving a feedback on its performance of the muscle strength training. According to the easy chair 20, it may be possible to increase the user's motivation for the training.

According to the easy chair 20, it may be possible to not only increase the user's motivation for the training but also automatically set the posture of the easy chair 20 to the posture suitable for the muscle strength training.

### Second Embodiment

The aforementioned moving mechanisms 26A to 26C according to the first embodiment are electrically operated. In contrast, the moving mechanisms according to the second embodiment are manually operated. In the second embodiment, the posture of the easy chair 20 cannot be automatically adjusted to the training posture.

Thus, in the second embodiment, when the indication of the user's intention to perform the muscle strength training is received, the user is notified that “the positions of the movable portions 23, 24, 25 should be displaced to the positions for the muscle strength training” in a form of recognizable information.

The above notification is provided by sound information using the speaker 28, image information using the touch panel 11, the touch panel 12 or the mobile terminal 13, or information combining the sound information and the image information.

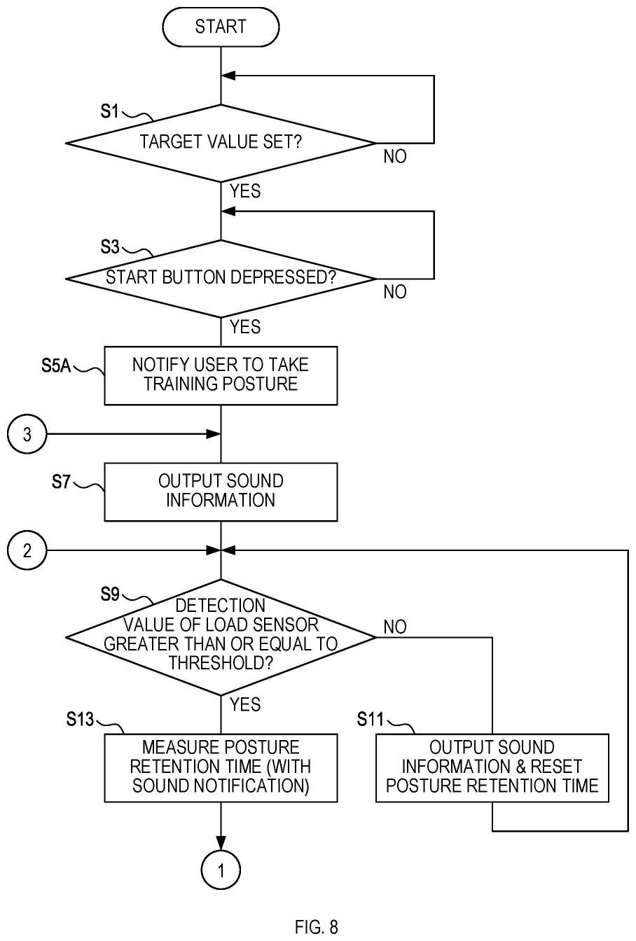

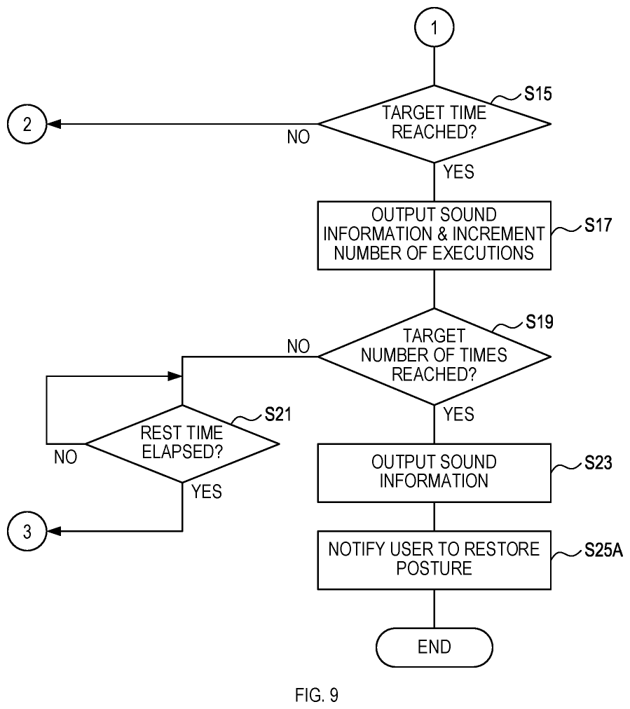

FIGS. 8 and 9 are an example flowchart showing an operation of the easy chair 20 when the user performs the muscle strength training using the easy chair 20 of the present embodiment. The present control is started when the user manipulates the operation portion 10, and selects the first training mode or the second training mode.

The following description explains differences from FIGS. 6 and 7 for the aforementioned first embodiment. Thus, components identical to the components in the aforementioned first embodiment are given the same reference numerals as those in the first embodiment, and overlapping explanations are omitted.

When it is determined that the start button is depressed (S3: YES), the control device 30 notifies the user that “the movable portions 23, 24, 25 should be adjusted to the training posture corresponding to the training in a form of recognizable information (SSA).

In addition, when it is determined that the number of executions has reached the target number of times (S19: YES), the control device 30 outputs sound information for ending the training from the speaker 28 (S23), and thereafter notifies the user to “restore the posture of the easy chair 20 to the posture before the training posture” (S25A).

The above notification (S25A) is also provided by sound information using the speaker 28, image information using the touch panel 11, the touch panel 12 or the mobile terminal 13, or information combining the sound information and the image information.

### Third Embodiment

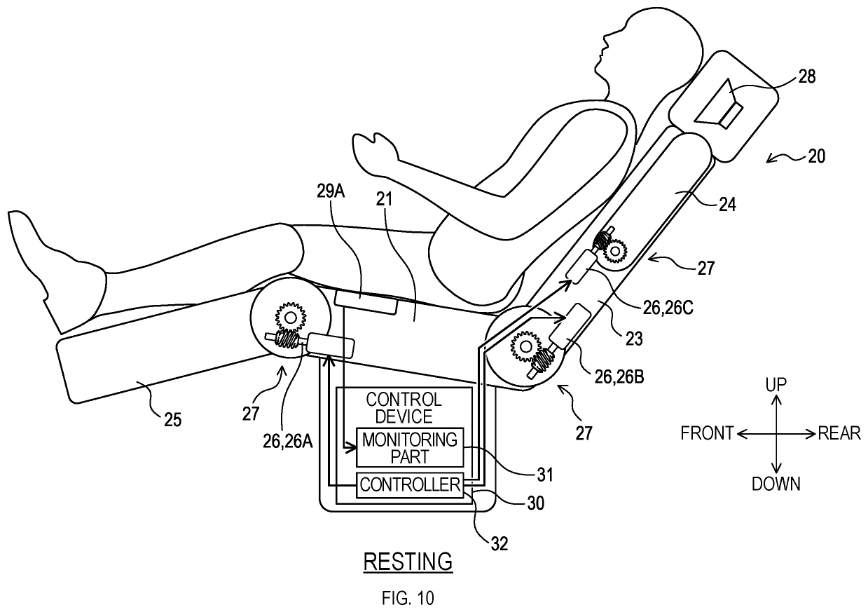

In the third embodiment, a load sensor 29A is arranged also in a portion corresponding to the thighs of the seated user, as shown in FIG. 10. Thus, in the third embodiment, “the detection value of the load sensor 29A in a state in which the thighs are raised” is smaller than “the detection value of the load sensor 29A in a state in which the thighs are lowered”.

The monitoring part 31 of the third embodiment detects the user's performance of the muscle strength training using changes in the detection value. Components identical to the components in the aforementioned first embodiment are given the same reference numerals as those in the first embodiment. Therefore, overlapping explanations are omitted in the present third embodiment.

### Fourth Embodiment

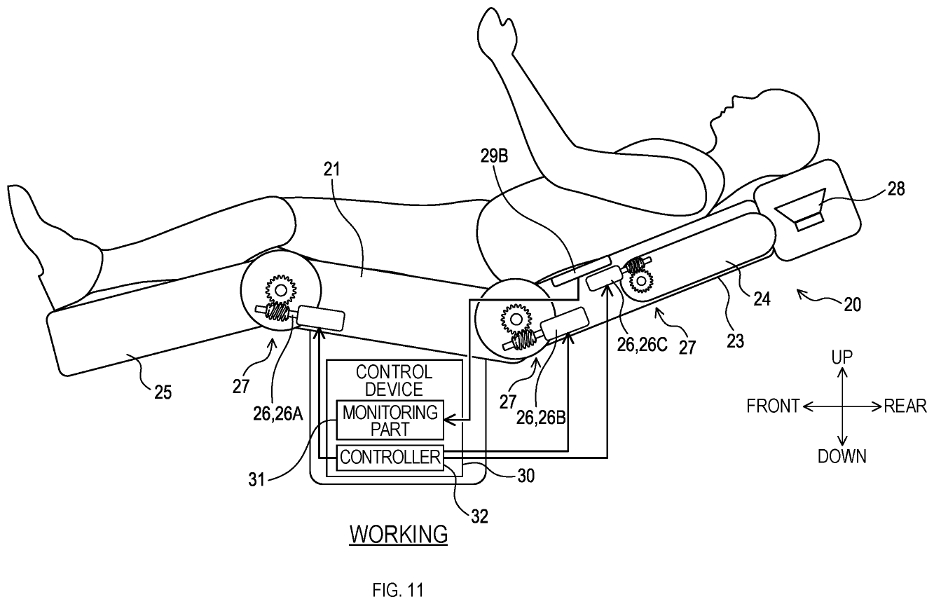

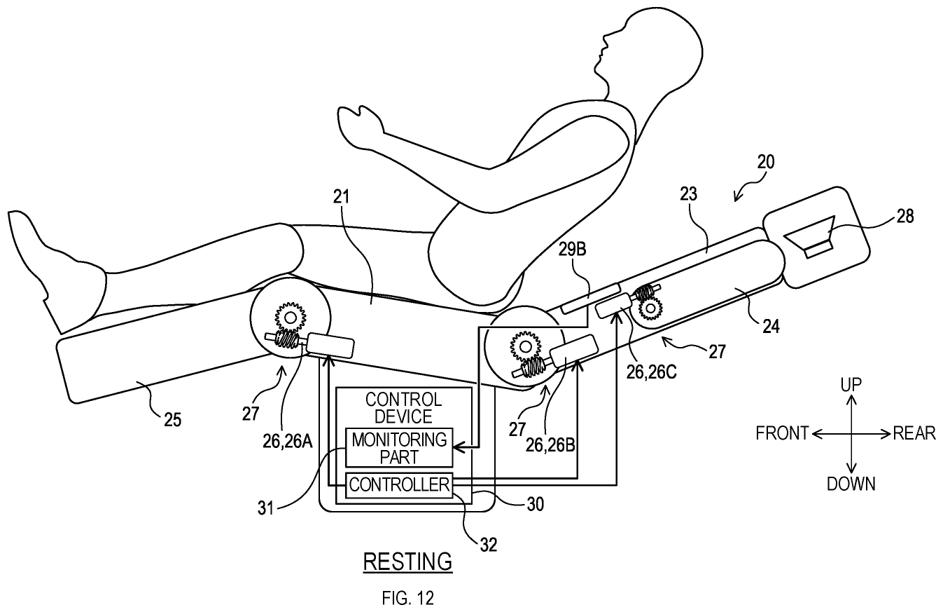

In the fourth embodiment, a load sensor 29B is arranged also in a portion corresponding to the back of the seated user, as shown in FIG. 11. Thus, in the fourth embodiment, as shown in FIGS. 11 and 12, “the detection value of the load sensor 29B in a state in which the upper body is raised” is smaller than “the detection value of the load sensor 29B in which the upper body is lowered”.

The monitoring part 31 of the fourth embodiment detects the user's performance of abs training using changes in the detection value. Components identical to the components in the aforementioned first embodiment are given the same reference numerals as those in the first embodiment. Therefore, overlapping explanations are omitted in the present fourth embodiment.

### Fifth Embodiment

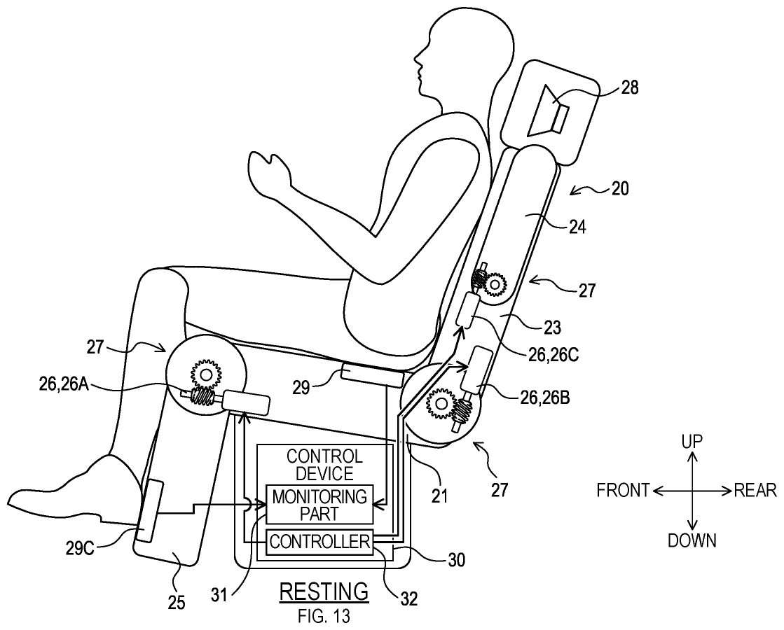

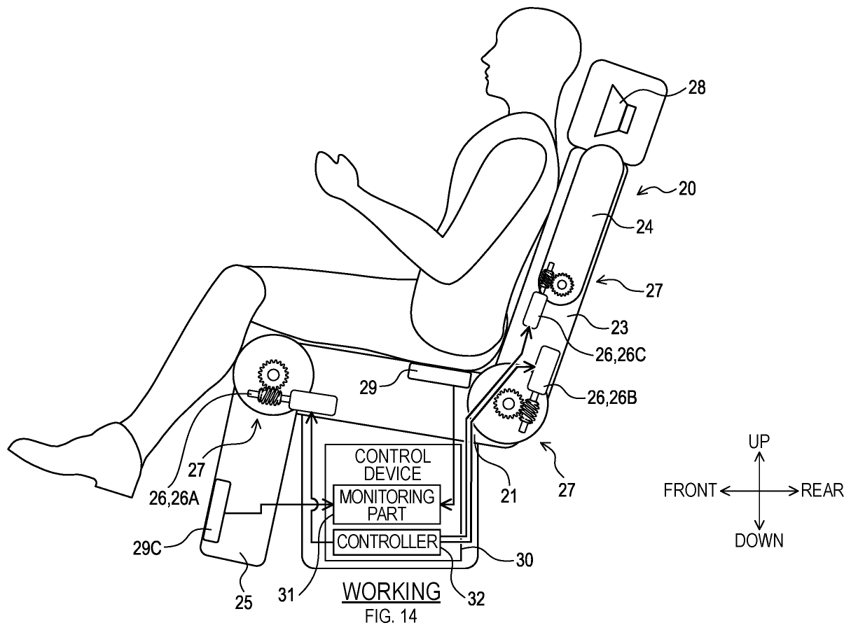

In the fifth embodiment, a load sensor 29C is arranged also in a portion corresponding to the calves of the seated user, as shown in FIG. 13. Thus, in the fifth embodiment, “the detection value of the load sensor 29C in a state in which the legs below the knees are raised” is smaller than “the detection value of the load sensor 29C in a state in which the legs below the knees are lowered”, as shown in FIGS. 13 and 14.

The monitoring part 31 of the fifth embodiment detects the user's performance of quadriceps or gastrocnemius training using changes in the detection value. Components identical to the components in the aforementioned first embodiment are given the same reference numerals as those in the first embodiment. Therefore, overlapping explanations are omitted in the present fifth embodiment.

### Sixth Embodiment

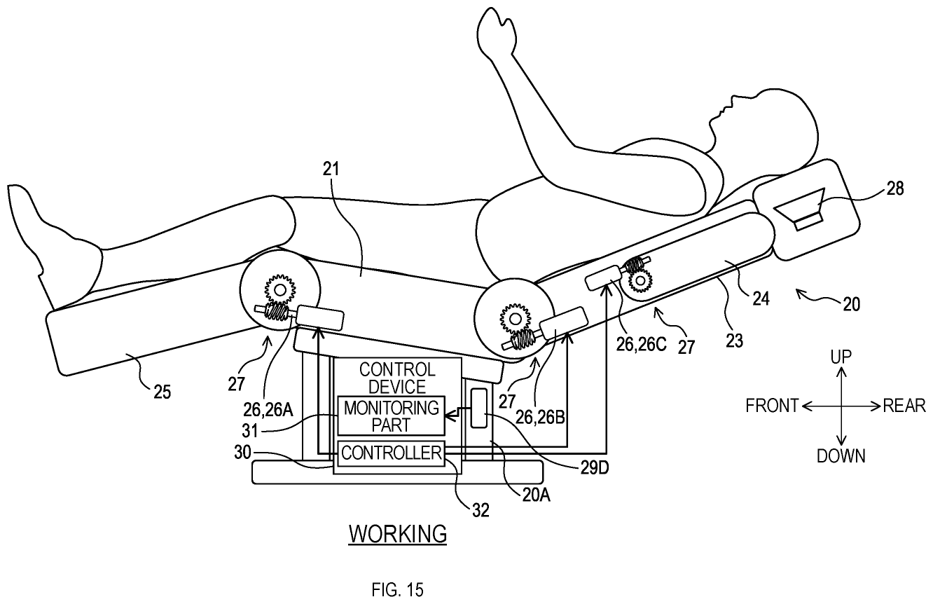

In the aforementioned embodiments, the performance of the muscle strength training is detected by detecting a load acting on the surface of the easy chair 20. In contrast, in the sixth embodiment, the performance of the muscle strength training is detected using changes in stress generated in a frame 20A of the easy chair 20, as shown in FIG. 15.

The changes in stress generated in the frame 20A are detected by a strain gauge 29D provided in the frame 20A. Thus, a detection value of the strain gauge 29D is input to the monitoring part 31, that is, the control device 30.

There is no limitation on where to arrange the strain gauge 29D. The strain gauge 29D does not have to be arranged in a position shown in FIG. 15, and may be arranged in other positions. Components identical to the components in the aforementioned first embodiment are given the same reference numerals as those in the first embodiment. Therefore, overlapping explanations are omitted in the present sixth embodiment.

### OTHER EMBODIMENTS

In the aforementioned embodiments, the detection result of the monitoring part 31 is provided to the user by sound information. However, a purpose of notifying the user of the detection result of the monitoring part 31 is to increase the user's motivation for the muscle strength training. Thus, the present disclosure is not limited to this as long as the manner of notification serves the purpose.

In the aforementioned first embodiment, when it is determined that the number of executions has reached the target number of times, the control device 30 restores the posture of the easy chair 20 to the posture before the training posture. The present disclosure is not limited to this. For example, the training posture may be maintained even when the number of executions reaches the target number of times.

The aforementioned embodiments include the electrical or manual posture change mechanism 27. The present disclosure is not limited to this. For example, the posture change mechanism 27 may not be provided. In other words, in this case, there is no function to change the posture of the easy chair 20 to the training posture, and at least the function to notify the user of the detection result of the monitoring part 31 is provided.

The moving mechanism 26 of the aforementioned embodiments is configured by the deceleration mechanism comprising an electric motor, a worm and a worm wheel. The present disclosure is not limited to this. For example, the moving mechanism may have a deceleration mechanism configured only by spur gears.

In the easy chair of the aforementioned embodiments, the user selects the training mode to be executed from among the two or more training modes. The present disclosure is not limited to this. For example, the easy chair may be configured such that only one training mode can be executed.

In the aforementioned embodiments, a specific target value needs to be set. The present disclosure is not limited to this. For example, a provider (manufacturer) of the easy chair may prepare a menu in advance, and the user may select the target value, etc. from the menu.

In the aforementioned embodiments, the user is notified of the detection result of the monitoring part 31 in order to increase the motivation for the muscle strength training. The present disclosure is not limited to this. For example, the user may be provided with music for increasing the motivation.

In the aforementioned embodiments, the movable portion for changing the posture (seated posture) includes the seatback 23, the armrest 24, and the ottoman 25. The present disclosure is not limited to this. For example, the movable portion may be configured by one of the seatback 23, the armrest 24, and the ottoman 25.

In the aforementioned embodiments, whether the user is performing the muscle strength training is detected by the load sensor or the strain gauge. The present disclosure is not limited to this. For example, the detection may be performed using an image taken by a camera.

In a configuration to detect whether the user is performing the muscle strength training by an image taken by a camera, the posture of the easy chair may be automatically adjusted to the training posture when performance of the muscle strength training is detected, and the posture of the easy chair may be automatically restored to the posture before the training posture when an end of the muscle strength training is detected, regardless of whether the start button is depressed.

In the aforementioned embodiment, an example of a vehicle seat has been described, but the present disclosure is not limited thereto. For example, the easy chair of the present disclosure may also be applied to seats for use in other vehicles, such as railroad vehicles, ships and boats, and aircrafts, as well as built-in seats for use in theaters, households, and so on.

The present disclosure should not be limited to the aforementioned embodiments, but may be implemented in any embodiment that falls within the spirit of the disclosure described in the aforementioned embodiments. Accordingly, the present disclosure may include a configuration obtained by combining at least two of the aforementioned embodiments or a configuration obtained by omitting some of the elements described in the drawings or the elements described with reference numerals in the aforementioned embodiment.

What is claimed is:

1. An easy chair with a seat body configured for a user to sit thereon, comprising:
a monitoring part configured to detect whether the user is performing muscle strength training on the seat body and detect the user's performance of the muscle strength training; and
a notification part configured to notify the user of a detection result of the monitoring part in a form of recognizable information.

2. An easy chair with a seat body configured for a user to sit thereon, comprising:
a posture change mechanism including a movable portion for changing a posture of the seat body, the posture change mechanism being configured to displace the movable portion to a position for muscle strength training;
a controller configured to control an operation of the posture change mechanism, the controller being configured to execute a first function to displace the movable portion to the position for the muscle strength training when receiving an indication of the user's intention to perform the muscle strength training;
a monitoring part configured to detect whether the user is performing the muscle strength training on the seat body and detect the user's performance of the muscle strength training; and
a notification part configured to notify the user of a detection result of the monitoring part in a form of recognizable information,
wherein the controller is configured to execute a second function to restore the movable portion to a state before the first function is executed, when it is determined by the monitoring part that the muscle strength training has ended.

3. An easy chair with a seat body configured for a user to sit thereon, comprising:
a posture change mechanism including a movable portion for changing a posture of the seat body;
a first notification part configured to notify the user to displace a position of the movable portion to a position for muscle strength training in a form of recognizable information when receiving an indication of the user's intention to perform the muscle strength training;
a monitoring part configured to detect whether the user is performing the muscle strength training on the seat body and detect the user's performance of the muscle strength training; and
a second notification part configured to notify the user of a detection result of the monitoring part in a form of recognizable information.

4. The easy chair according to claim 1, comprising:
a load sensor configured to detect a load acting on a surface of the seat body, wherein the monitoring part uses a detection value of the load sensor for determination.

5. The easy chair according to claim 2, comprising:
a load sensor configured to detect a load acting on a surface of the seat body, wherein the monitoring part uses a detection value of the load sensor for determination.

6. The easy chair according to claim 3, comprising:
a load sensor configured to detect a load acting on a surface of the seat body, wherein the monitoring part uses a detection value of the load sensor for determination.

7. A vehicle seat mounted on a vehicle, comprising:
a monitoring part configured to detect whether the user is performing muscle strength training on a seat body and detect the user's performance of the muscle strength training; and
a notification part configured to notify the user of a detection result of the monitoring part in a form of recognizable information.

8. A seat system with a vehicle seat mounted on a vehicle, comprising:
a posture change mechanism including a movable portion for changing a posture of the vehicle seat, the posture change mechanism being configured to displace the movable portion to a position for muscle strength training;
a controller configured to control an operation of the posture change mechanism, the controller being configured to execute a function to displace the movable portion to the position for the muscle strength training when receiving an indication of the user's intention to perform the muscle strength training;
a monitoring part configured to receive an input of a target value for the muscle strength training, detect whether the user is performing muscle strength training on the vehicle seat, and detect the user's performance of the muscle strength training; and
a notification part configured to notify the user of a detection result of the monitoring part and information associated with the input target value in a form of recognizable information.

9. The seat system according to claim 8, wherein
the monitoring part is configured to determine whether the muscle strength training has ended based on the target value, and
the controller is configured to restore the movable portion to a state before the function is executed when it is determined by the monitoring part that the muscle strength training has ended.
